(19) United States
(12) Patent Application Publication
(10) Pub. No.: US 2001/0056129 A1
(43) Pub. Date: Dec. 27, 2001

(54) Material made from a polyurethane gel and process for its production

(75) Inventors: Adolf Stender, Duderstadt (DE); Hermann Benkhoff, Duderstadt (DE)

Correspondence Address: Robert E. Muir, Esq., Husch & Eppenberger, LLC, Suite 1400, 401 Main Street, Peoria, IL, 61602-1241, US

(73) Assignee: TechnoGel GmbH & Co. KG

(21) Appl. No.: 09/825,318

(22) Filed: Apr. 3, 2001

(30) Foreign Application Priority Data
Apr. 3, 2000 (DE) 100 16 539.7

(51) Int. Cl. C08J 9/32

(52) U.S. Cl. 521/54

(57) ABSTRACT

A polyurethane gel filled with an expanded calcium carbonate offers an improved material for various applications, wherein the advantageous gel properties are retained, but at the same time negative properties, such as relatively high specific weight and high thermal conductivity, are avoided.

### BACKGROUND OF THE INVENTION

The present invention relates generally to polyurethane gels and more particularly to a material made from a polyurethane gel and a process for its production.

Polyurethane gels, that is undercured reaction products based on polyols and polyisocyanates, are generally known per se. Known undercured reaction products are used, for example, as pressure-distributing elements in upholstery for wheel-chairs, as shown in Patent EP 511 570 or for bicycle saddles, as shown in U.S. Pat. No. 5,330,249.

Patent EP 57 838 claims gels for avoiding decubitus which are characterized by undercuring. These gels are produced by reacting a polyisocyanate with long-chain polyols, which should be free of short-chain portions. These dimensionally stable gels, made from polyurethane raw materials may, be used as mattresses, mattress fillings, car seats and upholstery material. Patent EP 511 570 discloses improved undercured gels made from polyols and polyisocyanates, which are produced from mixtures of long-chain and short-chain polyethers. The polyol and polyisocyanate mixtures to be produced more favorably in terms of processing technology are preferably used as padding material in the shoe industry, as pads for avoiding or preventing injuries, face masks, as padding for horse saddles and in various other applications.

Known polyol and polyisocyanate mixtures have the disadvantage of high dead weight and high thermal capacity. As a result of the high dead weight of about 1.0 g/cm³, use is restricted to the limited number of applications in which the disadvantages of the additional weight do not outweigh the desirable pressure-distributing properties. Furthermore, the high thermal capacity of the polyurethane gel may be perceived as unpleasant in direct body contact, since body heat is clearly and perceptibly removed from the body to heat the particular gel compositions.

Patent German Offenlegungsschrift 4 308 445 mentions various processes or patent specifications (European granted patent 0 057 839; World application 88/01878; European 0 453 286) for producing gel foams using air, nitrogen and carbon dioxide. The reduction in specific weight and the reduction in the thermal capacity associated therewith are achieved to the required extent, however, the gels have the disadvantage that the cells formed adhere during pressure stress at the inner walls of the cells due to the very high self-adhesive behavior of undercured reaction products based on polyols and polyisocyanates. Furthermore, the cells represent a weakening of the gel matrix, which has a negative effect on mechanical properties such as extension at break and tensile strength. Furthermore, a cellular gel reverts more slowly to its starting position after loading, which is an undesirable characteristic. Also, shrinkage problems may occur with cellular gels, as are known from processing polyurethane foams.

The present invention clearly is a technical improvement over the prior art in that it comprises a gel composition, which has considerably reduced lower weight and thermal capacity, yet retains the typical, desirable gel properties, such as the absorption of shearing forces.

The present invention is directed to overcoming one or more of the problems set forth above.

### SUMMARY OF THE INVENTION

An aspect of the invention therefore consists in developing a material which avoids the above-mentioned disadvantages and combines the typical advantageous gel properties with a low specific weight and an overall lower thermal conductivity, as well as good durability and permanently consistent functional properties.

The above aspect is achieved according to the invention in that the material made from a polyurethane gel contains elastic microspheres as filler. The elastic microspheres of the present invention considerably reduce both the specific weight and the specific thermal conductivity of the material overall. In contrast to the cells of a foam, the microspheres within the polyurethane gel are permanently stable, so that the advantageous functional properties achieved are retained over the entire lifetime of the product. The elastic microspheres preferably include either a polymer material or a polyolefin, such as acrylonitrile copolymer or polyvinylidene chloride.

In another embodiment of the invention, the microspheres consist of expanded polymer materials, preferably expanded polyolefins.

It is advantageous if the elastic microspheres are coated with a cover layer of an inorganic material, preferably calcium carbonate. The inorganic coating should prevent agglomeration of the microspheres within the gel. Calcium carbonate is preferably used as the inorganic material, although other inorganic materials, in particular inorganic salts, are possible. In the applied sense, this embodiment of the elastic microspheres is high-volume expanded calcium carbonate.

The elastic microspheres incorporated into the material preferably have a diameter of 10 μm to 150 μm. The proportion of microspheres in the material is preferably between about 0.1 wt. % to 10 wt. %. Generally, the proportion of microspheres is freely selectable depending on the gel selected and is subject only to the condition that a stable material having the required properties is to be produced.

An undercured polyurethane based on polyols and polyisocyanates or polyethers and polyisocyanates is preferably used for the gel. The gel compositions may thus be produced using raw materials of isocyanate functionality of the polyol component of at least 5.2, preferably of at least 6.5, in particular of at least 7.5.

These aspects of the invention are merely illustrative of the innumerable aspects associated with the present invention and should not be construed as limiting in any manner.

The above and other aspects, features and advantages of the present invention will become apparent from the following detailed description when taken in conjunction with the accompanying drawings.

### DETAILED DESCRIPTION

According to a preferred embodiment, the polyol component for producing the gel consists of a) a mixture of one or more polyols having hydroxyl numbers below 112, and b) one or more polyols having hydroxyl numbers in the range from 112 to 116. The weight ratio of component a) to component b) lies between 90:10 and 10:90. Also, the isocyanate characteristic of the reaction mixture lies in the range 15 to about 60 and the product of isocyanate functionality and functionality of the polyol component is at least 6.15.

According to another preferred embodiment, the polyol component for producing the gel consists of one or more polyols having a molecular weight between 1,000 and 12,000 and an OH number between 20 and 112, wherein the product of the functionalities of the polyurethane-forming components is at least 5.2 and the isocyanate characteristic lies between 15 and 60. Furthermore, as isocyanates for gel production, those of the formula Q(NCO)ₙ may preferably be used, where n represents 2 to 4 and Q denotes an aliphatic hydrocarbon radical having 8 to 18 carbon atoms, a cycloaliphatic hydrocarbon radical having 4 to 15 carbon atoms, an aromatic hydrocarbon radical having 6 to 15 carbon atoms or an araliphatic hydrocarbon radical having 8 to 15 carbon atoms.

The isocyanates may be used in pure form or in the form of conventional isocyanate modifications, as are known to the experts in this field. Suitable modifications of the isocyanate component include urethanisation, allophanisation or biurethisation.

To achieve a previously stated aspect, a special process for producing the material from the polyurethane gel and the microspheres is also provided according to the invention, which is characterized in that elastic microspheres are incorporated as filler into the polyurethane gel during its production while largely avoiding air or gas introduction.

The microspheres of the preferred embodiments are preferably incorporated into the polyol component. Processing with the microspheres in the isocyanate is likewise possible. Incorporation of the microspheres must be carried out so that no additional air is also incorporated into the polyol or isocyanate. The air bubbles would cause the undesirable the negative properties that are commonly found in the gels that are known in the art. In particular, the tear-propagation strength would be considerably reduced because the air bubbles act as theoretical break points.

The microspheres are preferably formed from a polymer material, in particular a polyolefin, such as an acrylonitrile copolymer or polyvinylidene chloride, and are coated with an inorganic material, preferably calcium carbonate, before their processing. The microspheres are advantageously mixed into at least one initially placed component for polyurethane formation, while supplying high shearing energy using a high-speed mixer or with the aid of a dissolver.

Incorporation of the microspheres should be carried out so that a high degree of wetting the individual particles is guaranteed and so that introduction of air or gas is avoided as much as possible. To that end, processes for incorporating pulverulent products under vacuum are preferred. Two methods in particular are mentioned here specifically.

In the first process, polyol or isocyanate is situated in the mixing chamber of a high-speed mixer under vacuum (Messrs. Grieser, Maschinenbau- und Service GmbH, Chemiestraβe 19, Lampertheim). The microspheres coated with CaCO₃ are drawn in below the liquid level via the vacuum applied in the mixing chamber. Care should be taken to ensure that the particles of the invention are drawn in directly in the region of maximum angular speed of the stirrer operating at a high speed. The high shearing energy leads to homogeneous dispersion. The air drawn in by this process is removed from the mixture by the vacuum along with the action of constant stirring.

In the second tested process, the reaction component to be enriched with the microspheres is situated in an open tank and is pumped around by means of a dissolver. Negative pressure, with which the pulverulent particles are drawn into the reaction component, is produced in the dissolver disc (Messrs. YSTRAL, Ballrechten-Dottingen). Maximum wetting with correspondingly low air charging is thus guaranteed. The incorporated air is removed by applying a vacuum while stirring the reaction component treated with microspheres. The stirring mechanism is switched on or off at three-minute intervals. The rising air additionally collects below the blade surfaces due to the slow rotation of the blade mixer, so that larger air bubbles are formed. When the mixer is at a standstill, the large air bubbles rise in an accelerated manner, which considerably accelerates their evacuation.

The reaction component charged with the microspheres is advantageously added to the daily service tank of a 2K machine for further processing. To avoid separation of the specifically light hollow spheres, the dispersion of the invention is preferably continuously circulated.

### EXAMPLES

The following gel plates having separating agents applied to both sides were produced according to the processes described above using the isocyanate and polyol raw materials described in European patent EP 57 838 and EP 511 570.

In the examples below, the microspheres were incorporated into the polyol component. The polyol composition flow required is pumped via a precision pump to a metering gun with a downstream dynamic mixer. The isocyanate component necessary for polyaddition is also passed to the dynamic mixer by means of a separate high-precision pump and mixed homogeneously with the polyol component. Care should be taken in particular to ensure that the two components are mixed homogeneously, to ensure that the properties of the end product are uniform. The two homogeneously prepared components may be cast into a molding die, such as for example plates. The polyaddition reaction is accelerated by additional heating of the dies.

Component A is a trifunctional polyether polyol of OH number 28. It is produced by propoxylation of trimethylolpropane with subsequent ethoxylation (PO/EO=83/17). In addition, component A contains 0.1 wt. % of Coscat 83 (commercial product of Cosan Chemical Co.).

Component B is a modified aliphatic isocyanate from Bayer AG: Desmodur KA 8712.

### Example 1

Thickness 3.0 mm

Mixing ratio: 100:13 (component A: component B)

Component A: 97 parts by weight polyol +3 parts by weight highly elastic microspheres

(Dualite M 6001 AE, Lehmann & Voss & Co., Hamburg)

Component B: Isocyanate

### Example 2

Thickness: 3.0 mm

Mixing ratio: 100:13 (component A: component B)

Component A: 97 parts by weight polyol +3 parts by weight highly elastic microspheres

(Dualite MS 7000, Lehmann & Voss & Co., Hamburg)

Component B: Isocyanate

### Comparative Example 1

Thickness: 3.0 mm

Mixing ratio: 100:13 (component A: component B)

Component A: 100 parts by weight polyol

Component B: Isocyanate

Results:

| | Bulk density | Tensile strength | Extension at break |
|---|---|---|---|
| | [kg/m³] | [Kpa] | [%] |
| | DIN 53 420 | DIN 53 571 | DIN 53 571 |
| Example 1 | 864 | 892 | 335 |
| Example 2 | 756 | 767 | 388 |
| Comparative | 1059 | 455 | 343 |
| example 1 | | | |

The thermal conductivity was considerably reduced by the addition of highly elastic microspheres, which was detected by direct body contact. Test people could differentiate the plates produced using hollow spheres from the conventional gel plates with blindfolded eyes. According to a unified statement of all test people, the plates produced using hollow spheres were assessed as “warmer”. This can be explained by the lower thermal conductivity of the plates produced using the hollow spheres.

We claim:

1. A material comprising:
a polyurethane gel that includes elastic microspheres as filler.

2. The material according to claim 1, wherein the elastic microspheres includes polymer material.

3. The material according to claim 2, wherein the polymer material includes polyolefin.

4. The material according to claim 2, wherein the polymer material includes expanded polymer material.

5. The material according to claim 1, wherein the microspheres have a cover layer coating that includes an inorganic material.

6. The material according to claim 5, wherein the inorganic material includes calcium carbonate.

7. The material according to claim 1, wherein the microspheres have a diameter in a range of 10 μm to 150 μm.

8. The material according to claim 1, wherein a proportion of microspheres in the material is from 0.1% to 10% of total material weight.

9. The material according to claim 1, wherein the polyurethane gel includes an undercured reaction product of polyols and polyisocyanates.

10. The material according to claim 1, wherein the polyurethane gel includes an undercured reaction product of polyethers and polyisocyanates is used for the gel.

11. The material according to claim 1, wherein the polyurethane gel includes a polyol component having an isocyanate functionality of at least 5.2.

12. The material according to claim 1, wherein the polyurethane gel includes a polyol component having an isocyanate functionality of at least 6.5.

13. The material according to claim 1, wherein the polyurethane gel includes a polyol component having an isocyanate functionality of at least 7.5.

14. The material according to claim 1, wherein the polyurethane gel includes a polyol component that includes a mixture of:
a first component that includes one or more polyols having hydroxyl numbers below 112 and second component that includes one or more polyols having hydroxyl numbers in the range from 112 to 600, wherein a weight ratio of the first component to the second component is in a range from 90:10 to 10:90, an isocyanate characteristic of a reaction mixture of the first component and the second component lies in a range from 15 to 60 and a product of isocyanate functionality and functionality of the polyol component is at least 6.

15. The material according to claim 1, wherein the polyol component for producing the gel includes one or more polyols having a molecular weight in a range between 1,000 and 12,000 and an OH number in a range between 20 and 112 and a product of isocynate functionality and functionality of the one or more polyols is at least 5 and an isocyanate characteristic is in a range between 15 and 60.

16. The material according to claim 1, further including isocyanates utilized in producing the polyurethane gel, wherein the isocyanates are of a formula Q(NCO)ₙ, in which n represents 2 to 4 and Q selected from the group consisting of an aliphatic hydrocarbon radical having 8 to 18 C atoms, a cycloaliphatic hydrocarbon radical having 4 to 15 C atoms, an aromatic hydrocarbon radical having 6 to 15 C atoms and an araliphatic hydrocarbon radical having 8 to 15 C atoms.

17. The material according to claim 1, wherein the polyurethane gel includes pure form isocyanates utilized in production of the polyurethane gel.

18. The material according to claim 1, wherein the polyurethane gel includes modified isocyanates utilized in production of the polyurethane gel.

19. The material according to claim 1, wherein the polyurethane gel includes urethanised isocyanates utilized in production of the polyurethane gel.

20. The material according to claim 1, wherein the polyurethane gel includes allophanised isocyanates utilized in production of the polyurethane gel.

21. The material according to claim 1, wherein the polyurethane gel includes biurethised isocyanates utilized in production of the polyurethane gel.

22. A process for producing a material from a polyurethane gel comprising:
incorporating elastic microspheres as filler into the polyurethane gel during production of the polyurethane gel; and
avoiding introduction of gas into the polyurethane gel during the production of the polyurethane gel.

23. The process according to claim 22, further including:
adding the elastic microspheres to a polyol component of the polyurethane gel for further processing with the polyol component of the polyurethane gel.

24. The process according to claim 22, further including:
adding the elastic microspheres to a polyisocyanate component for further processing with the polyisocyanate component.

25. The process according to claim 22, wherein the elastic microspheres include a polymer material and an inorganic material coating.

26. The process according to claim 25, wherein the polymer material includes a polyolefin.

27. The process according to claim 25, wherein the inorganic material includes calcium carbonate.

28. The process according to claim 22, further including:
mixing the elastic microspheres into at least one polyurethane component with high shearing energy.

29. The process according to claim 28, wherein the high shearing energy is supplied with a high-speed mixer.

30. The process according to claim 22, further including:
utilizing a dissolving means to mix the elastic microspheres with at least one polyurethane component.
